(19) United States
(12) Patent Application Publication
(10) Pub. No.: US 2021/0035226 A1
(43) Pub. Date: Feb. 4, 2021

(54) Systems, Methods and Platform for Performing a Multi-Level Catastrophic Risk Exposure Analysis for a Portfolio

(71) Applicant: Aon Global Operations plc, Singapore Branch, Singapore (SG)

(72) Inventors: Kirk William Dybvik, Chaska, MN (US); Douglas Olson, Carver, MN (US)

(73) Assignee: Aon Global Operations plc, Singapore Branch, Singapore (SG)

(21) Appl. No.: 16/941,742

(22) Filed: Jul. 29, 2020

Related U.S. Application Data
(60) Provisional application No. 62/879,847, filed on Jul. 29, 2019.

(51) Int. Cl. G06Q 40/08; G06Q 10/06

(52) U.S. Cl. CPC G06Q 40/08; G06Q 10/0635

(57) ABSTRACT

In an illustrative embodiment, an automated system performs a multi-level risk exposure analysis for geographic locations, such as property locations. The system may include computing systems and devices for calculating, for locations in a portfolio, risk exposure amounts for an area that includes an insured location and including an analysis radius and identifying regions of interest having risk exposure amounts that exceed predetermined amounts due to combined exposure from a portion of the insured locations. The system may generate a grid of intermediate points that is applied to each region of interest. The system may calculate amounts of risk exposure for each of the intermediate points and retain any intermediate points with risk exposure amounts that exceed the amounts for the insured locations. The system may output a risk exposure analysis based on the risk exposure amounts for the insured locations and intermediate points of interest.

### RELATED APPLICATIONS

This application claims priority to U.S. Provisional Application Ser. No. 62/879,847 entitled “Systems, Methods and Platform for Performing a Multi-Level Catastrophic Risk Exposure Analysis for a Portfolio” and filed Jul. 29, 2019. This application is related to the following prior patent applications directed to catastrophic risk estimation and management: U.S. patent application Ser. No. 13/804,505, entitled “Computerized System and Method for Determining Flood Risk,” filed Mar. 14, 2013; U.S. patent application Ser. No. 15/460,985, entitled “Systems and Methods for Performing Real-Time Convolution Calculations of Matrices Indicating Amounts of Exposure,” filed Mar. 16, 2017; and U.S. Pat. No. 10,657,604 entitled “Systems, Methods, and Platform for Estimating Risk of Catastrophic Events,” issued May 19, 2020. All above identified applications are hereby incorporated by reference in their entireties.

### BACKGROUND

The present technology relates to determining likelihood of various natural and manmade catastrophic events (e.g., tornadoes, hurricanes, floods, wild fires, earthquakes, terrorist attacks) in given geographic locations and potential amounts of risk to properties and other structures posed by such catastrophic events.

It is known that models or other computer applications may be used to assess the potential liabilities of catastrophic events. Certain companies, such as insurance companies, may find information provided by these models/applications useful in determining their potential liability (i.e., risk exposure) based on the occurrence the event. These models/applications use, generate and store large amounts of data that need to be processed and analyzed to facilitate the determination of its potential liabilities based on the event. Additionally, catastrophic modeling software typically requires specialized training and a server installation. The existing methods are also time consuming, and are unable to provide real-time, nearly instantaneous, assessments of risk exposure. In some instances, underwriters send insurance application information to an analyst trained in using catastrophic modeling software, which can take twenty-four, to forty-eight hours, to even more than forty-eight hours to be processed, analyzed, and returned to the underwriter. As such, there is a need and desire for a better system and method for determining risk exposure of properties and other structures based on the occurrence of an event such as a catastrophic event. There is also a need for a system and method that is better able to able to accurately identify locations of greatest risk exposure to insurance underwriters, risk managers, and others in industries that have an interest in understanding how risk exposures impact geographic regions.

### SUMMARY OF ILLUSTRATIVE EMBODIMENTS

The inventors recognized a need for a risk exposure determination system that can efficiently and accurately determine risk exposures for locations of interest to insurance underwriters, risk managers, and others in industries that have an interest in understanding how risk exposures impact geographic regions. Aspects of the present disclosure are directed to a multi-level exposure determination system that calculates risk exposures at multiple levels, which provides a more accurate and robust picture of risk exposure to clients (e.g., catastrophic risk insurance underwriters) than conventional risk exposure calculation systems. In some conventional risk exposure assessment systems, risk exposures are calculated solely with respect to a client's insured locations without accounting for risk exposures at other locations. Further, these conventional systems are hampered by the inefficiencies of processing large amounts of geocoded information in catastrophic risk models.

The implementations of the system described herein provide for efficiently identifying areas of greatest risk exposure to clients based on risk exposures at both at insured locations and other locations in the surrounding region, providing valuable information to underwriters and risk managers regarding whether or not to underwrite new policies at particular locations. The implementations described herein are necessarily rooted in computing technology, which allows the system to perform multi-level risk exposure calculations in real time for both insured locations and other non-insured locations in ways that conventional systems have been unable to do. For example, the multi-level exposure determination system performs a first set of exposure calculations for areas surrounding currently insured locations and encompassing a user-identified geographic radius to quickly identify regions having the greatest risk exposure within the radius and eliminate from analysis the regions of least risk exposure. For the regions having the greatest risk exposure, the system applies a dynamic grid of intermediate points customized to the client's geographic radius of interest to identify other locations that may have an even greater risk exposure than the currently insured locations. The system further refines the calculated risk exposure amounts by optionally eliminating any location points having an exposure radius that overlaps a radius of other location points having a greater exposure. Eliminating overlap removes redundant exposure calculation results and provides clients with a more concise and/or usable representation of their catastrophic risk exposure than other conventional systems.

Further, the detailed solutions for efficiently identifying areas of greatest risk exposure represent a technical solution to the technical problem of efficiently processing complex geocoded data in computerized catastrophic risk models and generating accurate risk exposure predictions from those models. The multi-level risk exposure calculation approach provided herein in conjunction with applying variable-sized geographic grids to these catastrophic models provides a significant technical improvement over other grid-based risk exposure calculation systems. Specifically, the system improves performance by using a first iteration of processing to identify which insured locations and regions present a highest risk exposure and ruling out geographic regions that do not have potential for producing exposure clusters large enough to be of interest to the risk exposure analysis. Further, the system uses a tiling method to process subsets of data in an efficient manner. Additionally, the client can customize the resolution of intermediate grid points, which further improves the processing flexibility of the system.

In an illustrative embodiment, an automated system performs a multi-level risk exposure analysis for an insurance portfolio. The system may include computing systems and devices for calculating, for insured locations in a portfolio, risk exposure amounts for an area that includes an insured location and including an analysis radius and identifying regions of interest having risk exposure amounts that exceed predetermined amounts due to combined exposure from a portion of the insured locations. The system can generate a grid of intermediate points that is applied to each region of interest. The system can calculate amounts of risk exposure for each of the intermediate points and retain any intermediate points with risk exposure amounts that exceed the amounts for the insured locations. The system can output a risk exposure analysis based on the risk exposure amounts for the insured locations and intermediate points of interest.

The forgoing general description of the illustrative implementations and the following detailed description thereof are merely exemplary aspects of the teachings of this disclosure and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1A is a block diagram of a multi-level exposure determination system;

FIG. 1B is a portion of a geocoded map including insured locations;

FIG. 2 is a diagram of geographic tile size levels;

FIG. 3A is a diagram of a tile grouping including a center tile and associated adjacent tiles;

FIG. 3B is a portion of a geocoded map including exposure accumulation clusters surrounding insured locations;

FIG. 4A is a diagram of tile groupings;

FIGS. 4B and 4C show a portion of a geocoded map with overlaid tile groupings;

FIG. 5 is a diagram of an intermediate point grid overlaid on a buffered tile;

FIGS. 6A-6B is a diagram of intermediate points and insured locations associated with cluster exposure accumulation calculations;

FIG. 7 is a diagram representing elimination of cluster overlap by the multi-point exposure determination system;

FIG. 8 illustrates a flow chart of an example method for calculating risk exposure accumulations using a multi-level exposure analysis;

FIGS. 9A-9B illustrate a flow chart of an example method for performing an intermediate point exposure accumulation analysis;

FIG. 10 is a block diagram of an example computing system; and

FIG. 11 is a block diagram of an example distributing computing environment including a cloud computing environment.

### DETAILED DESCRIPTION OF ILLUSTRATIVE EMBODIMENTS

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

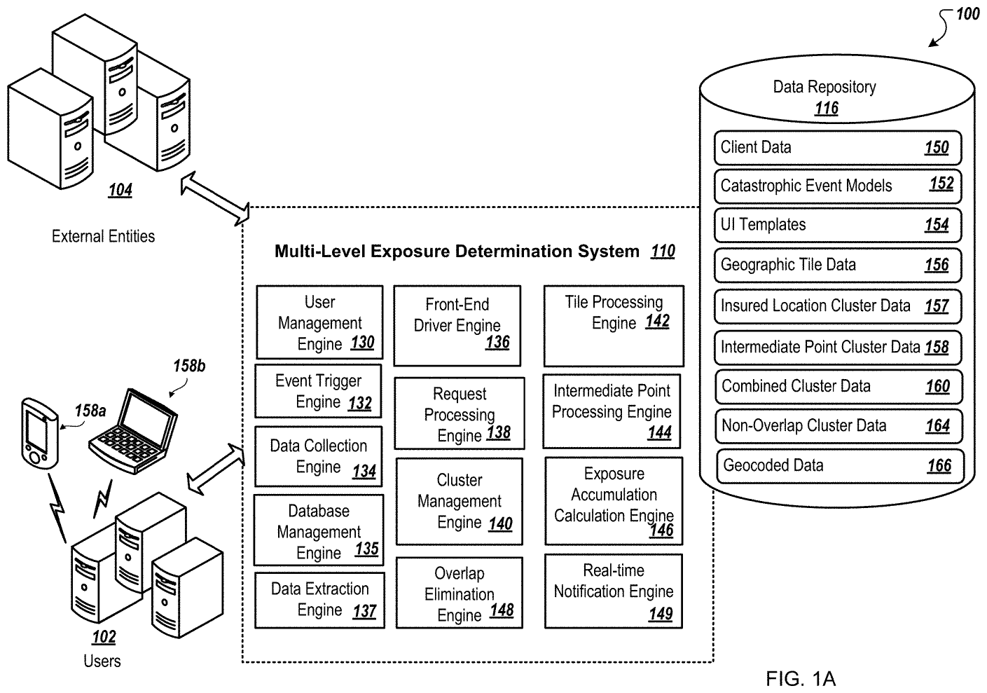

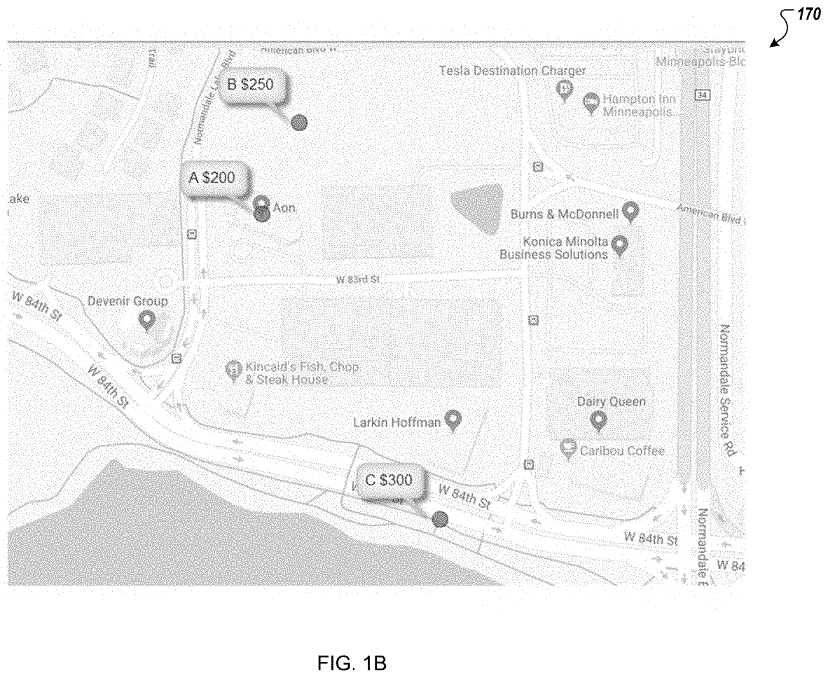

FIG. 1A is a diagram of an example environment 100 for a multi-level exposure determination system 110. The diagram illustrates relationships, interactions, computing devices, processing modules, and storage entities used to gather, generate, store, and distribute the information necessary to determine amounts of risk exposure to properties posed by various natural and manmade catastrophic events (e.g., tornadoes, hurricanes, floods, wild fires, earthquakes, terrorist attacks), which can be used to determine the costs associated with such risk exposures to catastrophic loss insurance providers. In some implementations, the multi-level exposure determination system identifies locations (including both insured locations and other non-insured locations) of highest risk exposure due to catastrophic events within a specified geographic radius.

In some implementations, the multi-level exposure determination system 110 may gather and process information from external entities 104 such as catastrophic event model providers in order to provide, in response to receiving a request, real-time catastrophic risk exposure assessments (costs due to losses from a potential catastrophic event and likelihood of incurring a loss, for example) to one or more users 102 (e.g., underwriters for catastrophic risk insurance policies). In some examples, the users 102 may use the information to determine whether or not to write an insurance policy for a property at a particular location based on an accumulated risk exposure calculated by the multi-level exposure determination system 110. Additionally, the multi-level exposure determination system 110 may use the calculated catastrophic risk exposure analyses to generate a client underwriting analysis, which can further assist the user in the policy writing decision process.

In certain embodiments, users 102 may connect to the multi-level exposure determination system 110 via a number of computing devices 158 distributed across a large network that may be national or international in scope. The network of users 102 can be separate and independent from networks associated with other entities in the exposure determination environment 100, such as the external entities 104. In addition, the data handled and stored by the users 102 may be in a different format than the data handled and stored by the other entities of the exposure determination environment 100. In some implementations, the users 102 may include, in some examples, insured personnel, brokers, insurance carriers, or any other person providing inputs to the multi-level exposure determination system 110. For example, underwriters for insurance carriers who underwrite catastrophic event insurance policies for homeowners or commercial properties and/or risk managers may provide a request to the system 110 for its risk exposure at a location with a radius of interest. In some implementations, the request may include a list of property locations in a portfolio of insurance policies. In other examples, the request may include identification information for a respective user that allows the system 110 to access stored client data 150 from data repository 116, which can include insurance portfolio data for the user. In response, the multi-level exposure determination system 110 generates, in real time based in part on the insured locations in the portfolio, a risk exposure analysis for the requested location.

In some implementations, the risk exposure analysis for the requested location can be performed by the multi-level exposure determination system 110 in real-time in response to receiving a user request from an external device 158. In addition to insured locations in a portfolio, the users 102 may also provide additional client data 150 to the system 110, which may include characteristics and statistics associated an insurance policy portfolio of an insurance carrier or broker. In some examples, these characteristics and statistics can include average and total coverage amounts, claims data, reinsurance statistics, and premium amounts. In other examples, the system 110 may automatically calculate portfolio statistics for a client in response receiving portfolio data file uploads from a user 102. In some examples, the client data 150 may also include at least one type of preferred catastrophic risk model. Each type of catastrophic event, in some implementations, may have more than one catastrophic risk model and/or a blend of more than one model that can be used to perform the exposure risk analysis. For example, tornado risk may be calculated using a model and/or algorithm provided by or based on a tornado model and/or algorithm developed by AIR Worldwide of Boston, Mass. or by Risk Management Solutions, Inc. of Silicon Valley, Calif. The system 110 can generate exposure risk analyses for the users 102 for each type of catastrophic event based on the preferred model.

External entities 104, in some implementations, include a number of computing devices distributed across a large network that may be national or international in scope. The network of external entities can be separate and independent from networks associated with other entities in the exposure determination environment 100, such as the users 102. In addition, the data handled and stored by the external entities 104 may be in a different format than the data handled and stored by the other participants of in the exposure determination environment 100. The external entities 104 can include any type of external system that provides data regarding catastrophic event occurrences such as government or private weather monitoring systems, first responder data systems, or law enforcement data systems. In some embodiments, external entities 104 may supply data into the multi-level exposure determination system 110 (e.g., on a periodic basis or responsive to occurrence of a catastrophic event). In some embodiments, the multi-level exposure determination system 110 connects to one or more external entities 104 to request or poll for information. For example, the multi-level exposure determination system 110 may be a subscriber of information supplied by one or more of the external entities 104, and the system 110 may log into one or more of the external entities 104 to access information.

In some examples, the external entities 104 may include catastrophic event model providers such as the U.S. Federal Emergency Management Agency (FEMA). Instead of or in addition to FEMA, the external entities 104 may also include other government agencies (of the US or another country) or may be nongovernmental public or private institutions that generate catastrophic event models 152 for any type of natural or manmade catastrophe. In an aspect where the catastrophic event is flooding, the external entities 104 may offer a specific set of flood risk products including, but not limited to, Flood Insurance Rate Maps (FIRMs) that may generally show base flood elevations, flood zones, and floodplain boundaries for specific geographic areas (the entirety of the U.S., for example). In some examples, the catastrophic event model providers may also offer periodic and/or occasional updates to catastrophic event models 152 due to changes in geography, construction and mitigation activities, climate change, and/or meteorological events.

In some embodiments, the multi-level exposure determination system 110 may include one or more engines or processing modules 130, 132, 134, 135, 136, 137, 138, 140, 142, 144, 146, 148, 149 that perform processes associated with performing multi-level risk exposure analyses in response to a request received from a user 102. In some examples, the processes performed by the engines of the multi-level exposure determination system 110 can be executed in real-time in order to provide an immediate response to a system input. In addition, the processes can also be performed automatically in response to a process trigger that can include a specific day or time-of-day or the reception of data from a data provider (e.g., one of the external entities 104 such as a catastrophic event model provider or property value provider), one of the users 102, or another processing engine.

In some implementations, the multi-level exposure determination system 110 may include a user management engine 130 that may include one or more processes associated with providing an interface to interact with one or more users (e.g., individuals employed by or otherwise associated with users 102) within the exposure determination environment 100. For example, the user management engine 130 can control connection and access to the multi-level exposure determination system 110 by the users 102 via authentication interfaces at one or more external devices 158 of the users 102. In some examples, the external devices 158 may include, but are not limited to, personal computers, laptop/notebook computers, tablet computers, and smartphones.

The multi-level exposure determination system 110, in certain embodiments, may also include a data collection engine 134 that controls the gathering of data from the external entities 104 such as the catastrophic model providers and property value providers. In some examples, the data collection engine 134 can typically receive data from one or more sources that may impact lead generation for users 102. For example, the data collection engine 134 can perform continuous, periodic, or occasional web crawling processes to access updated data from the external entities 104.

In addition, the multi-level exposure determination system 110 may include, in some implementations, a database management engine 135 that organizes the data received by the multi-level exposure determination system 110 from the external entities 104. In some examples, the database management engine 135 may also control data handling during interaction with users 102. For example, the database management engine 135 may process the data received by the data collection engine 134 and load received data files to data repository 116, which can be a database of data files received from the one or more data sources. In one example, the database management engine 135 can determine relationships between the data in data repository 116. For example, the database management engine 135 can link insured location cluster data 157, intermediate point cluster data 158, combined cluster data 160, and non-overlap cluster data 164 that are associated with a particular request and/or geographic region. In addition, the database management engine 135 may perform a data format conversion process to configure the received data into a predetermined format compatible with a format of the files within data repository 116.

In some implementations, the multi-level exposure determination system 110 may also include a real-time notification engine 149 that ensures that data input to the multi-level exposure determination system 110 is processed in real-time. In addition, the processes executed by the real-time notification engine 149 ensure interactions between the users 102 and the multi-level exposure determination system 110 are processed in real-time. For example, the real-time notification engine 149 may output alerts and notifications to the users 102 via user interface (UI) screens when data associated with the users 102 have been received by the data collection engine 134.

In some examples, the multi-level exposure determination system 110 may also include an event trigger engine 132, which can manage the flow of data updates to the multi-level exposure determination system 110. For example, the event trigger engine 132 may detect updates to catastrophic event models 152, geocoded data 166, or any other type of data collected or controlled by the multi-level exposure determination system 110. The event trigger engine 132 may also detect modifications or additions to the files of the data repository 116, which may indicate that new or updated data has been received. When a data update is detected at data repository 116, the event trigger engine 132 loads the updated data files to a data extraction engine 137. The event trigger engine 132 operates in real-time to update the data extraction engine 137 when updated data is received from the data sources. In addition, the event trigger engine 132 operates automatically when updated data is detected at the data repository 116. In addition, the data extraction engine 137 extracts data applicable to the multi-level exposure determination system 110 from data files received from the data sources.

In some examples, the multi-level exposure determination system 110 can also include a request processing engine 138 that processes exposure analysis requests received from users 102. In some implementations, users 102 submit requests for a risk exposure analysis at a UI screen provided by front-end driver engine 136 to the user's external device 158. The request can include a geographic area of interest to the user 102, which can be represented by a set of insured locations in an insurance portfolio. In some examples, the insured locations can be represented by geographic coordinates such as longitude/latitude. In other examples, the request can include identification information for the user 102 that directs the request processing engine 138 to the user's insurance portfolio information stored as client data 150 in data repository 116. For example, FIG. 1B illustrates a portion of a geocoded map 170 that includes three insured locations A, B, C associated with a user 102. In some examples, upon receiving a request from a user 102, the request processing engine retrieves positioning coordinates (latitude and longitude) and exposure values (referred to as total insurable value (TIV)) from client data 150 in data repository 116 as shown in Table 1, below:

TABLE 1

| Location | Latitude | Longitude | TIV |
|---|---|---|---|
| A | 44.854538 | −93.355294 | 200 |
| B | 44.8553 | −93.354855 | 250 |
| C | 44.852 | −93.3532 | 300 |

Returning to FIG. 1A, in some examples, the request can include one or more types of catastrophic risks that the user 102 is interested in evaluating for exposure accumulation. For example, the user 102 may wish to know the exposure accumulation due to earthquakes, floods, and hurricanes but may not wish to have terrorist events included in the analysis, and so the request can include filtering inputs to indicate such preferences. In another example, the request can indicate that the user 102 would like the system 110 to assess all types of relevant catastrophic events at the requested locations. In some examples, users 102 can indicate other types of data attribute preferences in the request such as specific lines of business. Additionally, the users 102 can indicate an amount of geocoding accuracy for insurance records evaluated by the system 110. For example, the request can indicate that records that do not geocode to rooftop or street level precision are to be eliminated from the analysis.

In some implementations, the request allows clients 102 to provide analysis parameters that affect the exposure accumulation calculations. In one example, one of the analysis parameters is an amount of granularity for the analysis, which controls the spacing of intermediate points as discussed further below. Coarse grained spacings result in faster runtimes while fine grained spacing analyze a larger number of intermediate points. In some examples, intermediate point processing engine 144 may automatically adjust the amount of granularity for an exposure accumulation analysis based on the availability of processing resources to the system 110 at a given time. In one example, the grid spacing amount corresponds to approximately 20 meters. A second analysis parameter included in the request is a number of clusters of interest for the system 110 to generate in response to the request.

In some embodiments, the user request also includes a third analysis parameter, which is a radius indicating how expansive the user 102 wants the risk exposure analysis to be with respect to the insured locations. For example, the radius corresponds to a distance value such as 0.25 mile, 0.5 mile, 1 mile, 5 miles, 10 miles, 50 miles, 100 miles, 200 miles, or any other value greater than, less than, or in between the specified values. In some examples, the request processing engine 138 can automatically determine the analysis radius based on a type of catastrophic event associated with the request. For example, the analysis radius may correspond to a blast radius for a bomb or an average area affected by a hail storm. Based on the radius specified by the user 102 in a submitted request, the request processing engine 138 identifies a geographic tile size for the multi-level exposure analysis, which in some examples can be a tile size that is greater than the specified radius. In some examples, data repository 116 stores geographic tile data 156, which includes geographic map data structures that are divided into different-sized tiles.

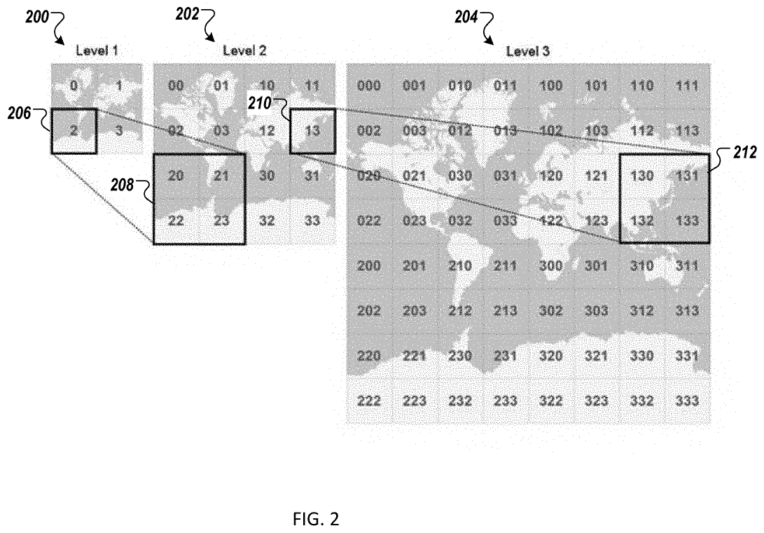

FIG. 2 shows a diagram of geographic tile size levels 200, 202, 204 that are stored as geographic tile data 156. In the illustrated example, each successively smaller tile size is four times smaller than the next largest tiles size. For example, for four tiles 208 in level 202 encompass the same geographic area as one tile 206 in level 200. Similarly, four tiles 212 in level 204 encompass the same geographic area as one tile 210 in level 202. While FIG. 2 illustrates three tile size levels 200, 202, 204, the geographic tile data 156 can include greater or fewer tile size levels. In one example, the geographic tile data 156 may include tens, hundreds, or thousands of different tile size levels. In some examples, the request processing engine 138 identifies the stored tile size level that is closest to but also greater than the radius specified in the request so that the tiles are as small as possible, but all tile heights and widths are greater than the requested radius.

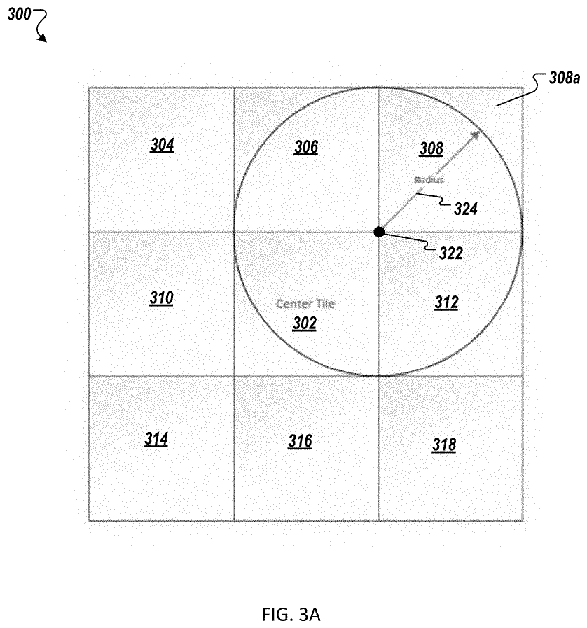

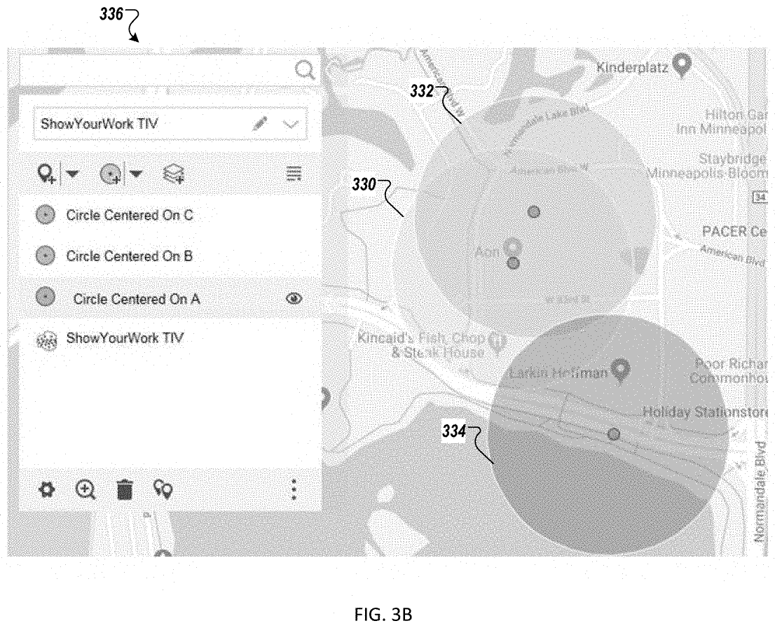

In some implementations, the tile-sizing techniques applied by the request processing engine 138 are based on the cluster-based approach used by the multi-level exposure determination system 110 to analyze catastrophic risk at requested locations. As discussed further below, the system 110 performs exposure analysis computations for clusters of eight tiles surrounding each center tile that includes an insured location as well as other intermediate locations. In some implementations, the tile-sizing techniques ensure that the only locations that could fall within the radius of a tile (referred to as a center tile) would fall within the center tile or one of eight adjacent tiles to the center tile. For example, FIG. 3A is a diagram of a tile grouping 300 including a center tile 302 and adjacent tiles 304, 306, 308, 312, 314, 316, 318. In one example, for a corner point 322 within center tile 302, the adjacent tiles 306, 308, 312 include the entire requested area with just a small false positive area 308a that falls outside of the requested radius. In some implementations, the tile size can be determined as a function of the requested radius and the minimum and maximum longitude and latitude values for the insured location points. In the example of the locations A, B, and C shown in FIG. 1B, the minimum latitude is 44.852 and the maximum latitude is 44.8553, which corresponds to a tile size of level 17 based on a requested analysis radius of 200 meters.

As is discussed further below, in some implementations, in order to quickly identify a subset of locations having a highest risk exposure that are closest to an insured location, a tile processing engine 142 identifies a tile 302 that at least one insured location falls within and exposure accumulation calculation engine 146 computes catastrophic risk exposure for the area of tile grouping 300. In some implementations, the tile processing engine 142 assigns each insured location (e.g., locations A, B, and C in FIG. 1B) to a tile of the identified size. For example, Table 2 below shows the tile key assignments for each of the locations A, B, and C. In this example, locations A and B fall within the same tile and location C falls within tile 3013. Therefore, tile 3010 has a total exposure accumulation of 450, and tile 3013 has a total accumulation of 300. In some examples, the total exposure accumulation values for each tile can be combined into a single table entry as shown below in Table 3, which can be used by the system 110 to efficiently perform exposure calculations during the processes described herein.

TABLE 2

| Name | Latitude | Longitude | TIV | TileKey @ level 17 |
|---|---|---|---|---|
| A | 44.854538 | 93.355294 | 200 | 3010 |
| B | 44.8553 | 93.354855 | 250 | 3010 |
| C | 44.852 | −93.3532 | 300 | 3013 |

TABLE 3

| TileKey @ level 17 | Tile Exposure Value | Location Count |
|---|---|---|
| 3010 | 450 | 2 |
| 3013 | 300 | 1 |

Returning to FIG. 1A, in some implementations, the multi-level exposure determination system 110 can also include a cluster management engine 140 that manages the interactions of tile processing engine 142, intermediate point processing engine 144, exposure accumulation processing engine 146, and overlap elimination engine 148. In some examples, cluster management 142 controls execution of processes for performing exposure accumulation calculations for insured location clusters, intermediate point clusters, and tile groupings. Additionally, the cluster management engine 148 can identify the highest exposure accumulations from insured location cluster data 157 and intermediate point cluster data 158 and combines the identified clusters into combined cluster data 160 that is sorted according to exposure accumulation value and is stored in data repository 116. In some examples, the cluster management engine 140 also sorts clusters according to exposure accumulations associated with each identified cluster (both insured location and intermediate point clusters).

In some implementations, the multi-level exposure determination system 110 may also include an exposure accumulation calculation engine 146 that calculates risk exposure accumulations for clusters associated with both insured locations and intermediate point locations. In some embodiments, the exposure accumulation calculation engine 146 accesses catastrophic event models 152 from data repository 116 for locations that fall within evaluated clusters. In some examples, the exposure accumulation calculation engine 146 calculates total exposure to a client 102 for all locations that fall within a respective exposure cluster. In some implementations, the exposure accumulation calculation engine 146 calculates risk exposure accumulations for each type of catastrophic event. In another example, based on the user request, the exposure accumulation calculation engine 146 may only calculate exposure accumulation values for one or a few types of catastrophic events.

For example, FIG. 3B shows a portion of a geocoded map 336 with exposure accumulation clusters surrounding the locations A, B, and C from FIG. 1B. In some implementations, exposure accumulation calculation engine 146 performs an initial set of exposure calculations for the insured locations buffered by the analysis radius. This initial set of exposure calculations aids in identifying both individual locations of significant exposure as well regions having a high density of exposure. As shown in FIG. 3B, exposure accumulation cluster 330 surrounds location A and includes location B for a total exposure accumulation value of 450. Similarly, cluster 332 surrounds location B and includes location A for a total exposure accumulation value of 450. Cluster 334 surrounds location C and does not include any other insured locations, resulting in a total exposure accumulation of 300. In some examples, the exposure accumulation calculation engine 146 also performs similar exposure calculations at intermediate point locations as described further below. This initial set of exposure calculations centered on insured locations is stored in data repository 116 as insured location cluster data 157.

Returning to FIG. 1A, in some implementations, the multi-level exposure determination system 110 may also include a tile processing engine 142 that identifies regions defined by tile groupings (a center tile plus eight surrounding adjacent tiles) that have the potential to produce exposure clusters that are greater than or equal to the initial set of exposure values centered on the insured locations. Identifying these high exposure regions allows the system 110 to avoid searching all possible locations for highest exposure values, which improves processing speeds and overall system efficiency. Additionally, identifying the highest exposure regions allows the system 110 to eliminate geographic areas that have lower amounts of risk exposure accumulation from further, more complex processing tasks (e.g., intermediate point processing). In some embodiments, the tile processing engine 142 can identify the high exposure regions using the previously identified tile information as well as tile information for adjacent tiles. In some examples, even center tiles with zero exposure can produce a high exposure cluster if any of the adjacent eight tiles have a high enough exposure concentration.

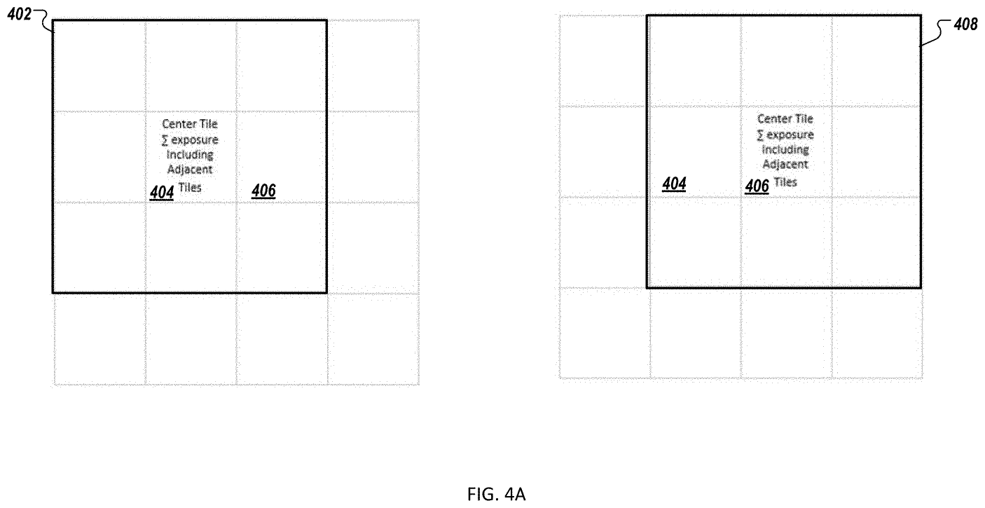

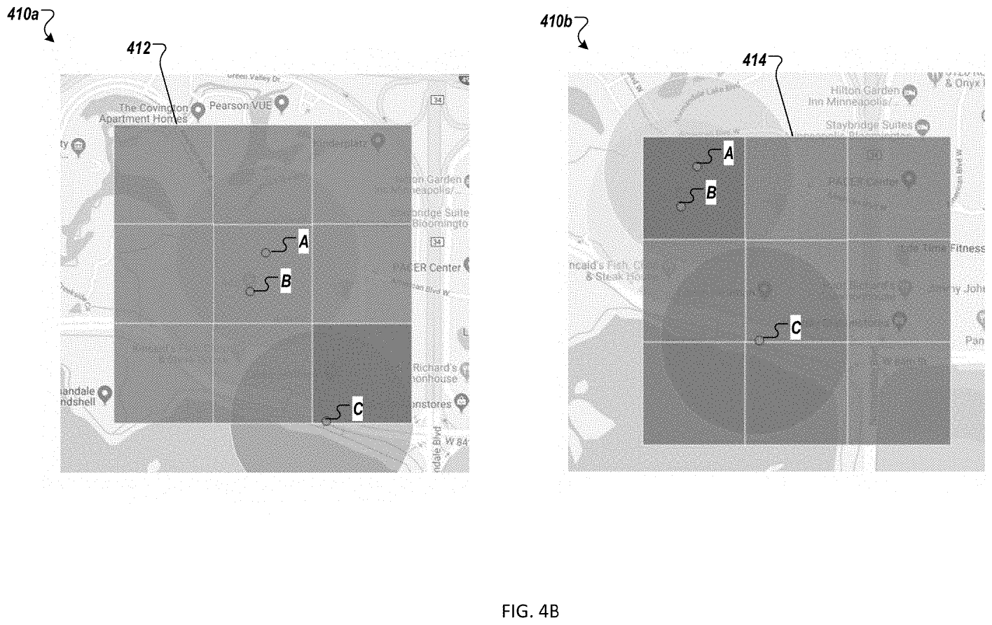

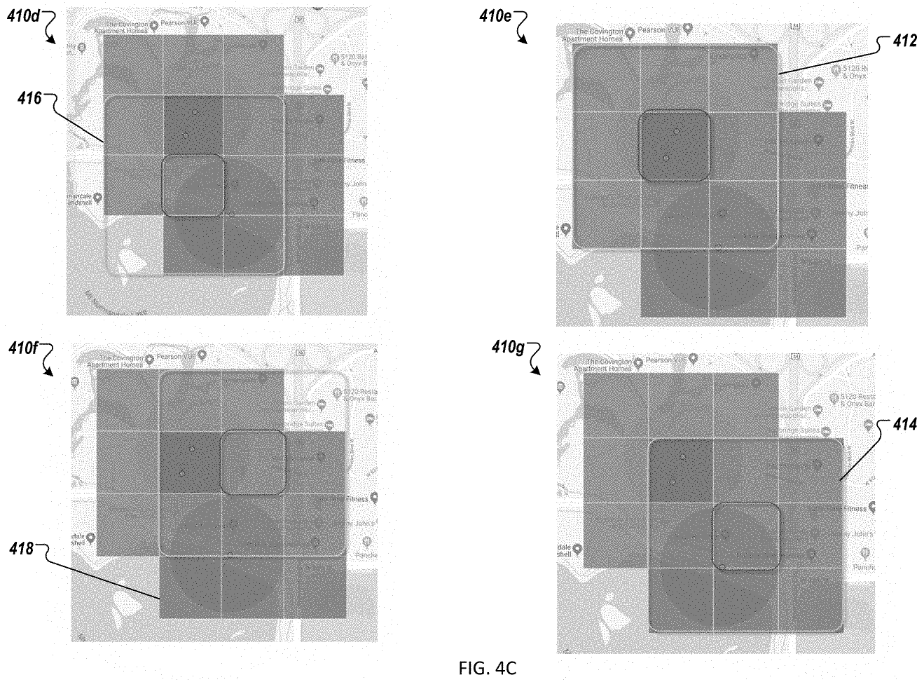

For example, FIG. 4A shows a diagram of tile groupings 402, 406. In some implementations, tile processing engine 142 generates a first insured location tile grouping 402 by identifying a center tile 404 that contains at least one respective insured location and locating the eight adjacent tiles surrounding the center tile 404. In one example, tile 406 is one of the adjacent tiles in tile grouping 402. Additionally, the tile processing engine 142 generates a second insured location tile grouping 408 with tile 406 as the center tile (one of the eight adjacent tiles in grouping 402) and eight adjacent tiles surrounding the center tile 406. In some examples, the tile processing engine 142 coordinates with exposure accumulation calculation engine 146 to calculate exposure accumulations for tile groupings 402, 408. If either of the calculated risk exposure accumulations for tile groupings 402 or 408 exceed previously calculated exposure accumulation values for the initial set of insured location clusters 157, then the associated tile grouping 402 and/or 408 is retained for intermediate point analysis.

FIGS. 4B and 4C show a portion of a geocoded map 410 overlaid with tile groupings associated with the locations A, B, and C from FIG. 1B. For example, as shown in FIG. 4B, the center tile in grouping 412 includes locations A and B, and location C falls within one of the adjacent tiles. Additionally, the center tile in grouping 414 includes location C, and locations A and B fall within one of the adjacent tiles. In some embodiments, tile processing engine 142 also treats each tile in tile groupings 412 and 414 as a center tile and calculates the exposure accumulation values for additional tile groupings 416 and 418 as shown in FIG. 4C using the tile exposure values shown in Table 3. In some examples, because the exposures associated with groupings 412-418 are greater than at least one of the insured location cluster calculations (e.g., cluster 334 in FIG. 3B), the center tiles associated with those groupings 412-418 can be retained for intermediate point exposure analysis as tiles of interest.

Returning to FIG. 1A, the multi-level exposure determination system 110, in some embodiments, also includes an intermediate point processing engine 144 that identifies intermediate point locations not necessarily associated with an insured location that may have increased catastrophic risk exposure due to multiple insured locations being located in close proximity to one another. Identifying intermediate point locations of increased risk exposure allows users 102 to obtain a more accurate picture of where their greatest exposure risks lie, which may not correspond to an insured location. For example, if a user 102, such as a property insurance company, has several insurance policies for properties within close proximity to one another, an intermediate point between the insured locations may have a higher risk exposure value than each individual insured location.

In some embodiments, the intermediate point processing engine 144 uses the tiles of interest sorted in order of risk exposure accumulation to generate sets of intermediate points that are analyzed for amount of exposure accumulation. In some examples, for each tile of interest flagged by tile processing engine 142 for further analysis, the intermediate point processing engine 144 applies a spatial buffer of the analysis radius around the tile that corresponds to the radius of interest submitted with the request and applies a grid of intermediate points to the buffered tile.

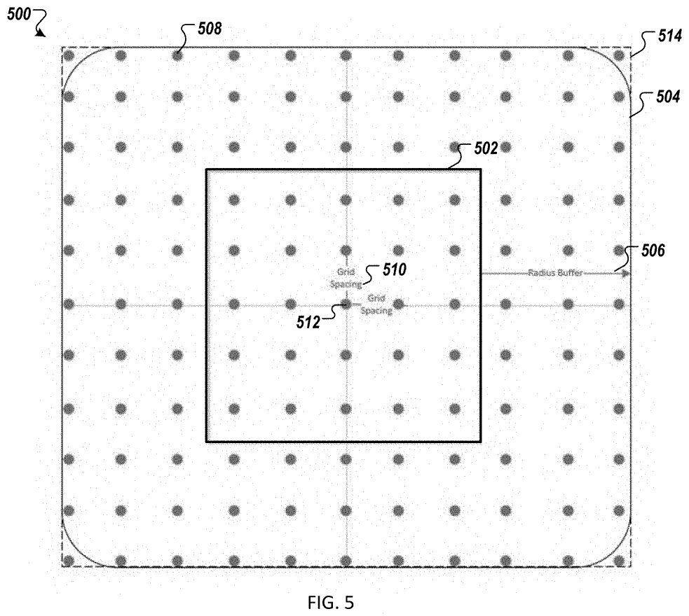

For example, FIG. 5 is a diagram of an intermediate point grid 500 overlaid on a buffered tile 504. As shown in FIG. 5, tile 502 represents a tile of interest that was retained for further analysis by tile processing engine 142. In some examples, intermediate point processing engine 144 applies spatial buffer 504 of analysis radius 506 to the bounds of the tile 502. To generate the grid 500 of intermediate points 508, in some implementations, the intermediate point processing engine 144 locates the midpoint 512 of the tile 502 and buffers the midpoint 512 by the grid spacing amount in each direction (north, south, east, west) 510. For example, FIG. 5B illustrates a grid spacing buffer 520 applied to the midpoint 512. In some examples, intermediate point processing engine 144 calculates a latitude stride amount 522 and a longitude stride amount 524 for applying intermediate points in each direction by calculating a distance from the midpoint 512 to the edges of the grid spacing buffer 520 in decimal degrees. In some examples, the intermediate point processing engine 144 applies intermediate points 508 in the north-south and east-west directions in increments of the latitude and longitude stride amounts until reaching the boundaries 514 of the spatial buffer 504 to create the intermediate point grid 500 shown in FIG. 5. In one example, the grid spacing amount 510 corresponds to decimal degrees between a midpoint 512 and outer edges of the buffered tile 504 in the north, south, east, and west directions such that the buffered tile 504 is overlaid with intermediate points 508 separated by the grid spacing amount 510.

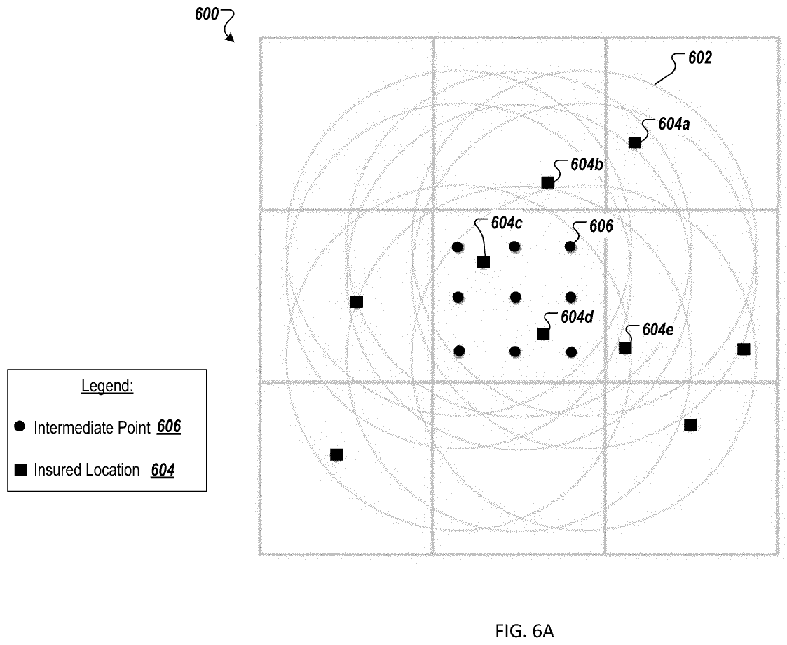

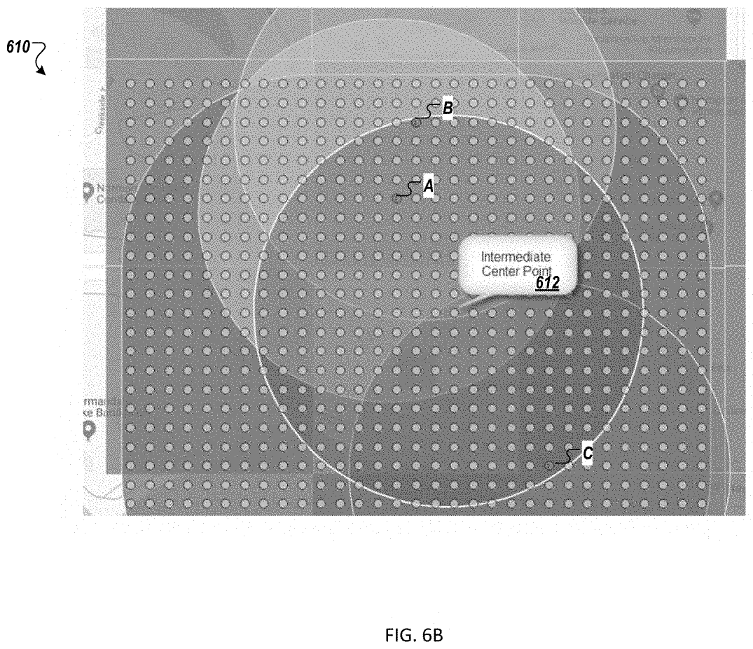

For a cluster of the analysis radius surrounding each of the intermediate points 508 in the grid 500, in some implementations, the exposure accumulation calculation engine 146 calculates an exposure accumulation value for each of the intermediate points as described above. Additionally, the exposure accumulation values associated with each of the intermediate points 508 are compared to the exposure accumulation values for the initial set of insured location cluster data 157, and intermediate point cluster data 158 for clusters exceeding the insured location clusters are retained. For example, FIG. 6A illustrates a diagram 600 of intermediate points 606 and insured locations 604 associated with cluster exposure accumulation calculations. For each identified insured location 604a-e that falls within the specified radius 602 of a respective intermediate point 606, in some examples, the exposure accumulation processing engine 146 calculates the exposure accumulation and assigns it to the respective intermediate point 606 such that the total exposure accumulation for the intermediate point 606 accounts for the exposure from all of the insured locations 604a-e that fall within the analysis radius 602 of the intermediate point 606. If the exposure accumulation for the respective intermediate point 606 is greater than the exposure accumulation for any of the insured location clusters from the initial analysis stored as insured location cluster data 157, then the cluster management engine 140 retains the key and the total exposure accumulation for the intermediate point 606, which is saved as intermediate point cluster data 158 in data repository 116.

FIG. 6B illustrates a diagram 610 of intermediate points and insured locations A, B, and C from the example shown in FIG. 1B. As shown in the diagram 610, a region of intermediate points 612 located where the analysis radius for each location A, B, and C overlaps corresponds to the region that produces the highest exposure accumulation. This is because a cluster of the analysis radius centered on one of the intermediate points in region 612 contains all of the three locations A, B, and C.

Returning to FIG. 1A, the multi-level exposure determination system 110 can also include an overlap elimination engine 148 that ensures that none of the retained clusters of the insured location cluster data 157 from the initial analysis and intermediate point cluster data 158 overlap with one another. In some implementations, cluster management engine 140 can sort the insured location cluster data 157 and intermediate point cluster data 158 according to exposure accumulation, which is saved in data repository as combined cluster data 160. In some examples, the overlap elimination engine 148 traverses the combined cluster data 160 associated with a request from highest to lowest exposure accumulation and removes overlapping clusters from the exposure analysis.

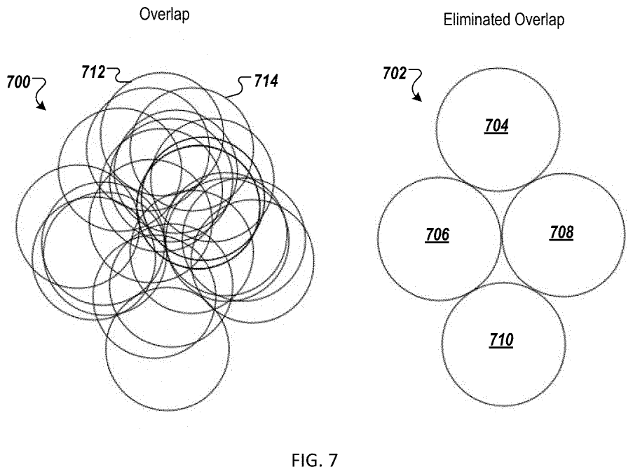

For example, FIG. 7 shows diagrams of overlapping clusters 700 and clusters after the overlap elimination engine 148 has removed the overlapping clusters from analysis 702. In some implementations, diagram 700 represents combined cluster data 160 associated with a request. If a cluster 712 overlaps another cluster 714 that has a higher exposure accumulation value, then overlap elimination engine 148 removes the overlapping cluster 712 with the lower exposure accumulation value from the analysis. Once the overlap elimination engine 148 has traversed the entire list and removed all of the overlapping cluster data, then in some implementations, all of the cluster data for the retained clusters are stored in data repository 116 as non-overlap cluster data 164. For example, diagram 702 shows non-overlapping clusters 704, 706, 708, 710 that have been retained after the overlap elimination engine 148 has processed all of the combined cluster data shown in diagram 700. In some embodiments, the overlapping clusters, such as clusters 712, 714 include redundant exposure information and prevent information for other areas of interest from being included in the analysis. Therefore, removing the overlapping clusters from the analysis provides the technical benefit of removing redundancy in the information provided to users 102 by the system 110.

In some implementations, the multi-level exposure determination system 110 may also include a front-end driver engine 136 that controls dissemination of data and interactions with users 102 through one or more UI screens that may be output to the external devices 158 in response to queries received from the users 102. In some embodiments, the front-end driver engine 136 generates customized UI screens for presentation to a user 102 using one or more UI templates 154 stored in data repository 116. In some examples, the users 102 may input client data 150 and/or queries for risk exposure analyses at one or more locations at UI screens. In another example, the users 102 can supply insurance portfolio data for multiple properties simultaneously by uploading client data 150 as a tabular spreadsheet or data file. For example, the properties included in the tabular spreadsheet may be properties associated with a particular insurance policy portfolio maintained by a user 102. In response to receiving the inputs at the UI screen, the front-end driver engine 136 may output, in real-time, an exposure risk analysis for the requested location. In some examples, the exposure accumulation analysis may include potential loss amounts at one or more insured locations or other intermediate locations within the requested radius. Additionally, the exposure risk analysis may also include exposure accumulation values for the non-overlap cluster data 164 associated with a request as well as the associated cluster locations.

In some implementations, the front-end driver engine 136 may cause geocoded data 166 (e.g., maps corresponding to a location of an indicated property in the submitted application) to be dynamically displayed on the front-end UI to allow a user to interact with the information stored in the data repository 116. For example, the front-end driver engine 136 may display exposure cluster data (e.g., non-overlap cluster data 164) for the requested location overlaid on a respective map for the requested location. In addition, the geospatial data included in the UI screen may also include a geocoded description of insured locations and/or intermediate exposure locations that may include latitude/longitude coordinates, address, building type, and geocode accuracy. In one example, the front-end of the multi-level exposure determination system 110 may be implemented as a web application that a user 102 (e.g., insurance provider) accessed through a web browser running on external devices 158. In some embodiments, the front-end of the system 110 may also be a full-fledged application or mobile app that runs on external devices.

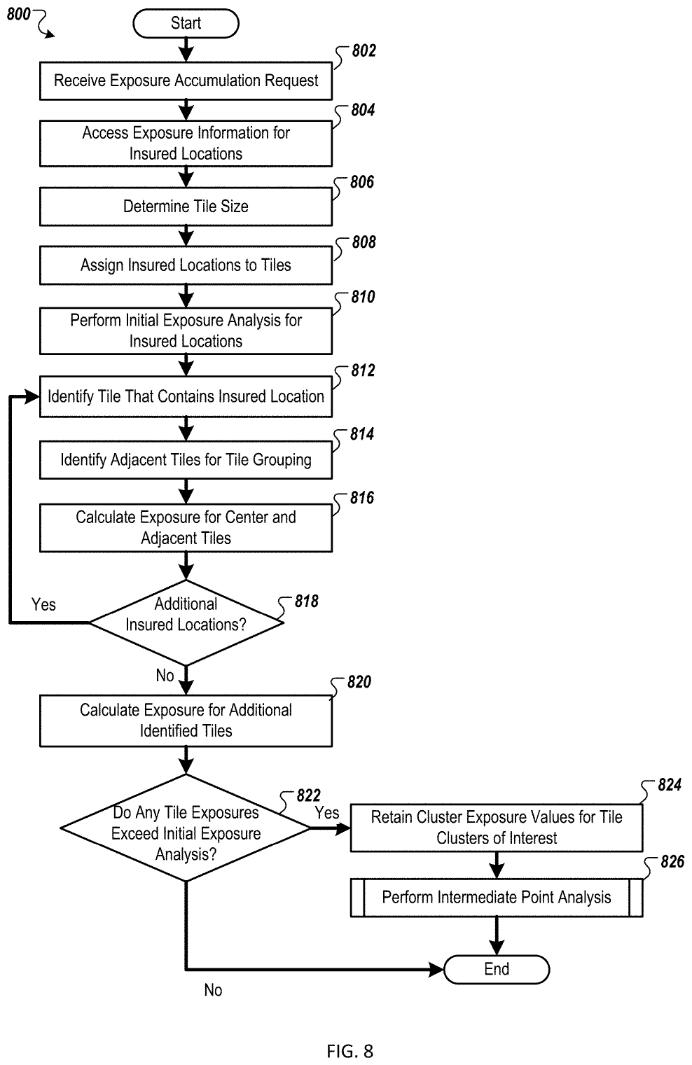

FIG. 8 illustrates a flow chart of an example method 800 for calculating risk exposure accumulations using a multi-level exposure analysis in response to receiving a user request for a risk exposure analysis of a portfolio. In some implementations, the method 800 is performed by request processing engine 138, cluster management engine 140, tile processing engine 142, intermediate point processing engine 144, exposure accumulation calculation engine 146, overlap elimination engine 148, and/or front-end driver engine 136.

In some implementations, the method 800 commences with receiving an exposure analysis request from a system user 102 (802). In some implementations, users 102 submit requests for a risk exposure analysis at a UI screen provided by front-end driver engine 136 to the user's external device 158. The request can include a geographic area of interest to the user 102, which can be represented by a set of insured locations in an insurance portfolio. In some examples, the insured locations can be represented by geographic coordinates such as longitude/latitude. In other examples, the request can include identification information for the user 102 that directs the request processing engine 138 to the user's insurance portfolio information stored in data repository 116 as well as types of catastrophic risks for evaluation by the system 110. In some embodiments, the user request also includes analysis parameters such as a radius indicating how expansive the user 102 wants the risk exposure analysis to be with respect to the insured locations, an amount of granularity associated with the request, and a number of cluster results for the system 110 to output. In some examples, responsive to receiving the request, the request processing engine 138 accesses exposure information for insured locations from data repository 116 and applies any filter preferences included in the request (e.g., lines of business, geocoding accuracy) (804).

Based on the radius specified by the user 102 in a submitted request, in some examples, the request processing engine 138 identifies a geographic tile size for the multi-level exposure analysis, which in some examples can be a tile size that is greater than the radius specified in the request (806). In some examples, the request processing engine 138 identifies a tile size that is closest to but also greater than the radius specified in the request so that the tiles are as small as possible, but all tile heights and widths are greater than the requested radius. In some implementations, the tile size can be determined as a function of the requested radius and the minimum and maximum longitude and latitude values for the insured location points. In the example of the locations A, B, and C shown in FIG. 1B, the minimum latitude is 44.852 and the maximum latitude is 44.8553, which corresponds to a tile size of level 17 based on a requested analysis radius of 200 meters. In some examples, tile processing engine 142 assigns each insured location to a tile of the identified tile size (e.g., locations A, B, and C in FIG. 1B) (808). For example, Table 2, above, shows the tile key assignments for each of the locations A, B, and C. In this example, locations A and B fall within the same tile and location C falls within tile 3013.

In some implementations, exposure accumulation calculation engine 146 performs an initial set of exposure calculations for the insured locations buffered by the analysis radius (810). As shown in FIG. 3B, exposure accumulation cluster 330 surrounds location A and includes location B for a total exposure accumulation value of 450. Similarly, cluster 332 surrounds location B and includes location A for a total exposure accumulation value of 450. Cluster 334 surrounds location C and does not include any other insured locations, resulting in a total exposure accumulation of 300. This initial set of exposure calculations centered on insured locations is stored in data repository 116 as insured location cluster data 157.

In some embodiments, tile processing engine 142 identifies a center tile that each insured location falls within (e.g., tile 3010 or 3013 in Tables 2 and 3) (812) and identifies the eight adjacent tiles that surround the center tile (for example, center tile 302 and adjacent tiles 304, 306, 308, 310, 312, 314, 316, 318 in FIG. 3A), which form a tile grouping (814). In some implementations, the tile processing engine 142 coordinates with exposure accumulation calculation engine 146 to calculate exposure accumulations for each the identified tile groupings (816). For example, FIG. 4B shows a portion of a geocoded map 410 with overlaid with tile groupings associated with the locations A, B, and C from FIG. 1B. For example, as shown in FIG. 4B, the center tile in grouping 412 includes locations A and B, and location C falls within one of the adjacent tiles. Additionally, the center tile in grouping 414 includes location C, and locations A and B fall within one of the adjacent tiles.

Once the exposure accumulations have been calculated for all of the tile groupings where the center tile contains an insured location (818), then the tile processing engine 142 also calculates exposure accumulations for additional identified tiles (e.g., adjacent tiles) (820). As shown in FIG. 4C, tile processing engine 142 also treats each tile in tile groupings 412 and 414 as a center tile and calculates the exposure accumulation values for additional tile groupings 416 and 418 using the tile exposure values shown in Table 3.

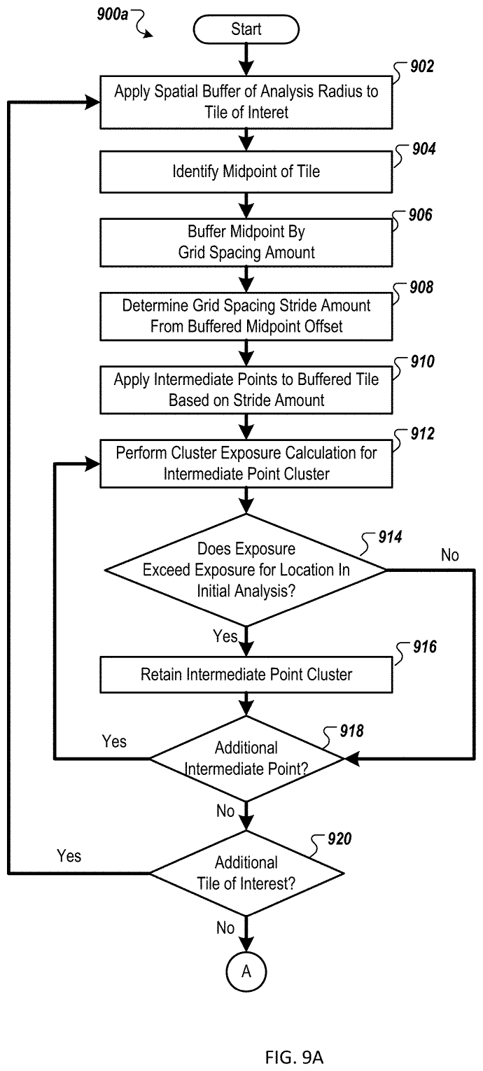

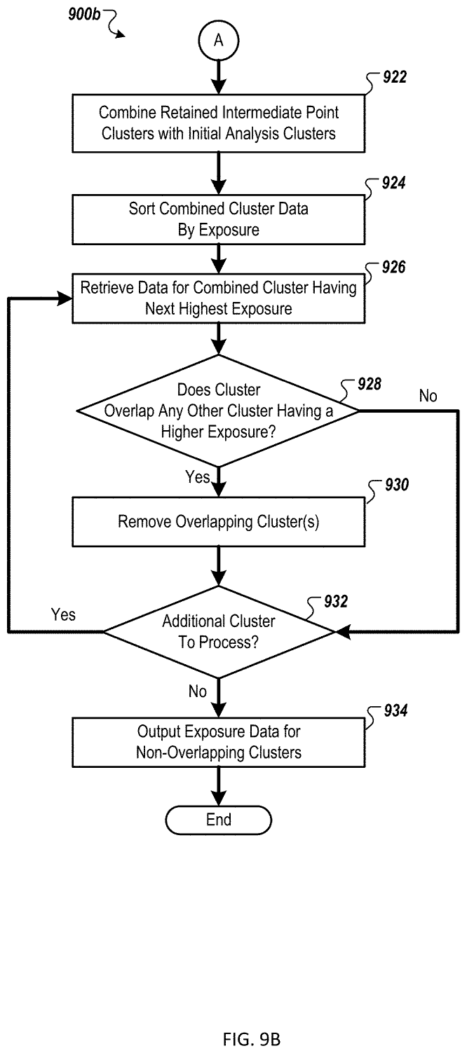

If the calculated exposure accumulation values for any of the tile groupings exceed any previously calculated exposure accumulation values for the insured locations in the initial exposure analysis (822), then in some implementations, the associated tile keys and exposure accumulation values are retained for intermediate point processing as tile clusters of interest (824). Identifying these high exposure regions allows the system 110 to avoid searching all possible locations for highest exposure values, which improves processing speeds and overall system efficiency. Additionally, identifying the highest exposure regions allows the system 110 to eliminate geographic areas that have lower amounts of risk exposure accumulation from further, more complex processing tasks (e.g., intermediate point processing). In the example shown in FIG. 4C, because the exposures associated with groupings 412-418 are greater than at least one of the insured location cluster calculations (e.g., cluster 334 in FIG. 3B), the center tiles associated with those groupings 412-418 can be retained for intermediate point exposure analysis as tiles of interest. In some examples, the system 110 performs an intermediate point exposure analysis on the retained insured locations of interest (e.g., insured location cluster data 157), which is discussed in detail below for FIGS. 9A-9B (826).

Although illustrated in a particular series of events, in other implementations, the steps of the risk exposure accumulation calculation process 800 may be performed in a different order. For example, assigning insured locations to tiles (808) may be performed before, after, or simultaneously with performing the initial exposure analysis for insured locations (810). Additionally, in other embodiments, the process may include more or fewer steps while remaining within the scope and spirit of the risk exposure accumulation calculation process 800.

FIGS. 9A-9B illustrate a flow chart of an example method 900 for performing an intermediate point exposure accumulation analysis, which corresponds to intermediate point exposure analysis (824) in FIG. 8. In some examples, the method 900 is performed by cluster management engine 140, intermediate point processing engine 144, exposure accumulation calculation engine 146, overlap elimination engine 148, and/or front-end driver engine 136.

In some implementations, the method 900 commences with intermediate point processing engine 144 generating a buffered tile (e.g., buffered tile 504 in FIG. 5) around one of the insured locations of interest that were retained by tile processing engine 142 as insured location cluster data 157 (902). In some examples, the intermediate point processing engine 144 applies a buffer radius around the tile for an insured location of interest that corresponds to the radius submitted with the request. To generate the grid 500 of intermediate points 508, in some implementations, the intermediate point processing engine 144 locates the midpoint 512 of the tile 502 (904) and buffers the midpoint 512 by the grid spacing amount in each direction (north, south, east, west) 510 (906). For example, FIG. 5B illustrates a grid spacing buffer 520 applied to the midpoint 512. In some examples, intermediate point processing engine 144 calculates a latitude stride amount 522 and a longitude stride amount 524 for applying intermediate points in each direction by calculating a distance from the midpoint 512 to the edges of the grid spacing buffer 520 in decimal degrees (908). In some examples, the intermediate point processing engine 144 applies intermediate points 508 in the north-south and east-west directions in increments of the latitude and longitude stride amounts until reaching the boundaries 514 of the spatial buffer 504 to create the intermediate point grid 500 shown in FIG. 5 (910).

In some implementations, the exposure accumulation calculation engine 146 calculates the exposure accumulation value for each intermediate point (e.g., intermediate point 508 in FIG. 5) that includes a cluster area of the analysis radius surrounding the intermediate point (912). In some embodiments, For example, for each identified insured location that falls within the specified radius of a respective intermediate point (e.g., insured locations 604a-e fall within radius 602 of intermediate point 606 in FIG. 6), the exposure accumulation processing engine 146 calculates the exposure accumulation and assigns it to the respective intermediate point. Therefore, in some examples, the total exposure accumulation for the intermediate point accounts for the risk exposure from all of the insured locations that fall within the specified radius of the intermediate point. If the exposure accumulation for the respective intermediate point is greater than the exposure accumulation for any of the insured location clusters stored as insured location cluster data 157 (914), then in some embodiments, the cluster management engine 140 retains the key and the total exposure accumulation for the intermediate point, which is saved as intermediate point cluster data 158 in data repository 116 (916).

If all of the intermediate points for all of the tiles of interest have been processed by intermediate point processing engine 144 (918, 920), then in some implementations, cluster management engine 140 combines the retained clusters of the insured location cluster data 157 and intermediate point cluster data 158 into combined cluster data 160 (922). In some examples, the combined cluster data 160 is sorted by exposure accumulation value (924) so that the overlap elimination engine 148 can traverse the combined cluster data 160 associated with a request from highest to lowest exposure accumulation to remove overlapping clusters from the exposure analysis (e.g., see overlapping cluster diagram 700 in FIG. 7). In some examples, overlap elimination engine 148 retrieves cluster data from combined cluster data 160 for the cluster having a next highest exposure accumulation value, starting with the cluster with the second-highest exposure accumulation (926).

If the retrieved cluster overlaps any cluster having a higher exposure (928), then in some examples, overlap elimination engine 148 removes the overlapping cluster from the combined cluster data 160 and the risk exposure analysis (930). In some embodiments, if the overlap elimination engine 148 has traversed the entire set of combined cluster data 160 (932), the only remaining clusters are non-overlapping clusters (e.g., clusters 704, 706, 708, 710 in diagram 702 in FIG. 7), which can be stored in data repository 116 as non-overlap cluster data 164. In some implementations, front-end driver engine 136 can output the cluster data for the non-overlapping clusters to an external device 158 of the user 102 submitting the exposure analysis request (934). In one example, the front-end driver engine 136 may display exposure cluster data (e.g., non-overlap cluster data 164) for the requested location as a heat map overlaid on a respective map for the requested location.

Although illustrated in a particular series of events, in other implementations, the steps of the intermediate point exposure analysis process 900 may be performed in a different order. For example, generating the buffered tile around tile of interest (902) may be performed before, after, or simultaneously with identifying the midpoint of the tile of interest (904) and buffering the midpoint by the grid spacing amount (906). Additionally, in other embodiments, the process may include more or fewer steps while remaining within the scope and spirit of the intermediate point exposure analysis process 900.

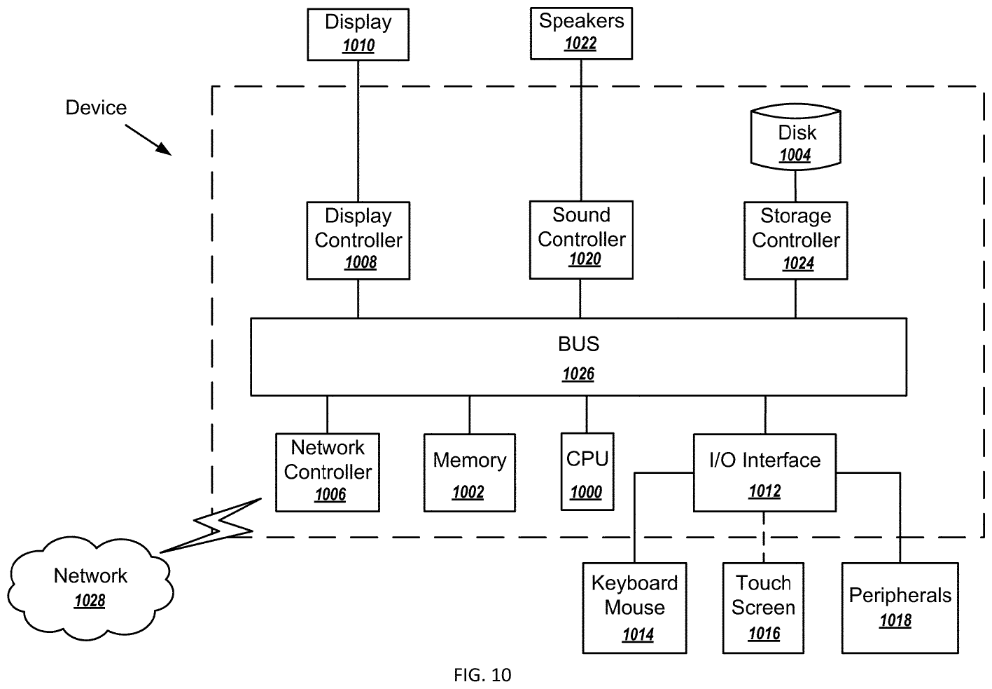

Next, a hardware description of the computing device, mobile computing device, or server according to exemplary embodiments is described with reference to FIG. 10. The computing device, for example, may represent the external entities 104, the users 102, or one or more computing systems supporting the functionality of the multi-level exposure determination system 110, as illustrated in FIG. 1A. In FIG. 10, the computing device, mobile computing device, or server includes a CPU 1000 which performs the processes described above. The process data and instructions may be stored in memory 1002. The processing circuitry and stored instructions may enable the computing device to perform, in some examples, the method 800 of FIG. 4A or the method 900 of FIGS. 9A-9B. These processes and instructions may also be stored on a storage medium disk 1004 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device, mobile computing device, or server communicates, such as a server or computer. The storage medium disk 1004, in some examples, may store the contents of the data repository 116 of FIG. 1A, as well as the data maintained by the external entities 104 and the users 102 prior to accessing by the multi-level exposure determination system 110 and transferring to the data repository 116.

Further, a portion of the claimed advancements may be provided as a utility application, background daemon, or component of an operating system, or combination thereof, executing in conjunction with CPU 1000 and an operating system such as Microsoft Windows 10, UNIX, Solaris, LINUX, Apple MAC-OS and other systems known to those skilled in the art.

CPU 1000 may be a Xeon or Core processor from Intel of America or an Opteron processor from AMD of America, or may be other processor types that would be recognized by one of ordinary skill in the art. Alternatively, the CPU 1000 may be implemented on an FPGA, GPU, ASIC, PLD or using discrete logic circuits, as one of ordinary skill in the art would recognize. Further, CPU 1000 may be implemented as multiple processors cooperatively working in parallel to perform the instructions of the inventive processes described above.

The computing device, mobile computing device, or server in FIG. 10 also includes a network controller 1006, such as an Intel Ethernet PRO network interface card from Intel Corporation of America, for interfacing with network 1028. As can be appreciated, the network 1028 can be a public network, such as the Internet, or a private network such as an LAN or WAN network, or any combination thereof and can also include PSTN or ISDN sub-networks. The network 1028 can also be wired, such as an Ethernet network, or can be wireless such as a cellular network including EDGE, 3G, 4G, and 5G wireless cellular systems. The wireless network can also be Wi-Fi, Bluetooth, or any other wireless form of communication that is known. The network 1028, for example, may support communications between the multi-level exposure determination system 110 and any one of the external entities 104 and users 102.

The computing device, mobile computing device, or server further includes a display controller 1008, such as a NVIDIA GeForce GTX or Quadro graphics adaptor from NVIDIA Corporation of America for interfacing with display 1010, such as a Hewlett Packard HPL2445w LCD monitor. A general purpose I/O interface 1012 interfaces with a keyboard and/or mouse 1014 as well as a touch screen panel 1016 on or separate from display 1010. General purpose I/O interface also connects to a variety of peripherals 1018 including printers and scanners, such as an OfficeJet or DeskJet from Hewlett Packard. The display controller 1008 and display 1010 may enable presentation of user interfaces to external devices 158 of users 102.

A sound controller 1020 is also provided in the computing device, mobile computing device, or server, such as Sound Blaster X-Fi Titanium from Creative, to interface with speakers/microphone 1022 thereby providing sounds and/or music.

The general purpose storage controller 1024 connects the storage medium disk 1004 with communication bus 1026, which may be an ISA, EISA, VESA, PCI, or similar, for interconnecting all of the components of the computing device, mobile computing device, or server. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

One or more processors can be utilized to implement various functions and/or algorithms described herein, unless explicitly stated otherwise. Additionally, any functions and/or algorithms described herein, unless explicitly stated otherwise, can be performed upon one or more virtual processors, for example on one or more physical computing systems such as a computer farm or a cloud drive.

Reference has been made to flowchart illustrations and block diagrams of methods, systems and computer program products according to implementations of this disclosure. Aspects thereof are implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

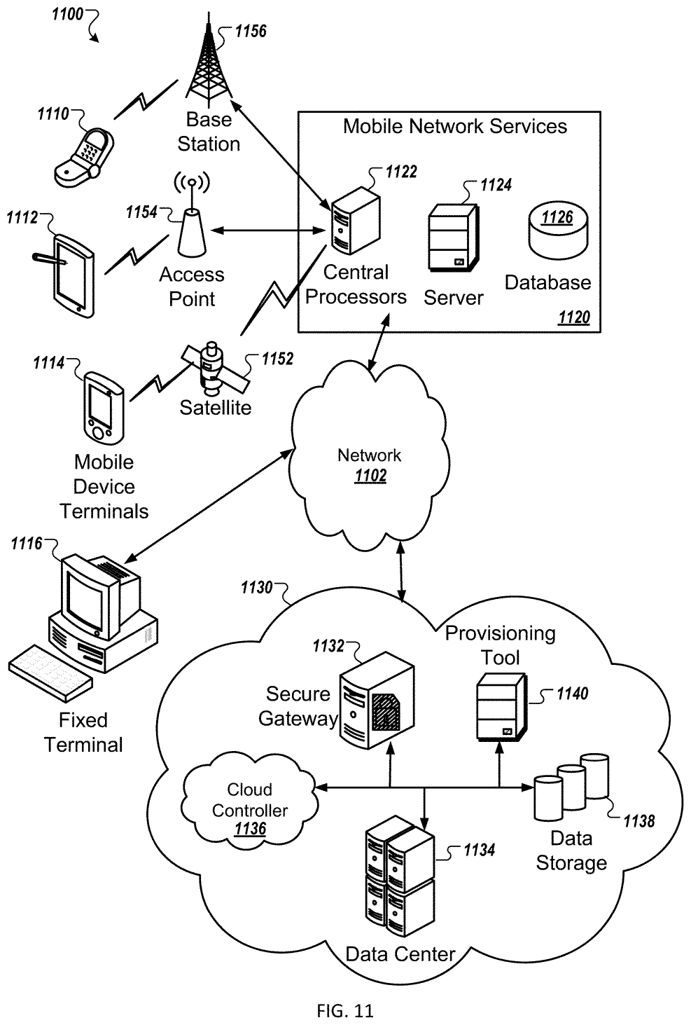

The functions and features described herein may also be executed by various distributed components of a system. For example, one or more processors may execute these system functions, wherein the processors are distributed across multiple components communicating in a network. The distributed components may include one or more client and server machines, which may share processing, as shown on FIG. 11, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

In some implementations, the described herein may interface with a cloud computing environment 1130, such as Google Cloud Platform™ to perform at least portions of methods or algorithms detailed above. The processes associated with the methods described herein can be executed on a computation processor, such as the Google Compute Engine by data center 1134. The data center 1134, for example, can also include an application processor, such as the Google App Engine, that can be used as the interface with the systems described herein to receive data and output corresponding information. The cloud computing environment 1130 may also include one or more databases 1138 or other data storage, such as cloud storage and a query database. In some implementations, the cloud storage database 1138, such as the Google Cloud Storage, may store processed and unprocessed data supplied by systems described herein. For example, the client data 150, catastrophic event models 152, UI templates 154, geographic tile data 156, insured location cluster data 157, intermediate point cluster data 158, combined cluster data 160, non-overlap cluster data 164, and/or geocoded data 166 may be maintained by the multi-level exposure determination system 110 of FIG. 1A in a database structure such as the databases 1138.

The systems described herein may communicate with the cloud computing environment 1130 through a secure gateway 1132. In some implementations, the secure gateway 1232 includes a database querying interface, such as the Google BigQuery platform. The data querying interface, for example, may support access by the multi-level exposure determination system 110 to data stored on any one of the external entities 104 and the users 102.

The cloud computing environment 1130 may include a provisioning tool 1140 for resource management. The provisioning tool 1140 may be connected to the computing devices of a data center 1134 to facilitate the provision of computing resources of the data center 1134. The provisioning tool 1140 may receive a request for a computing resource via the secure gateway 1132 or a cloud controller 1136. The provisioning tool 1140 may facilitate a connection to a particular computing device of the data center 1134.

A network 1102 represents one or more networks, such as the Internet, connecting the cloud environment 1130 to a number of client devices such as, in some examples, a cellular telephone 1110, a tablet computer 1112, a mobile computing device 1114, and a desktop computing device 1116. The network 1102 can also communicate via wireless networks using a variety of mobile network services 1120 such as Wi-Fi, Bluetooth, cellular networks including EDGE, 3G, 4G, and 5G wireless cellular systems, or any other wireless form of communication that is known. In some examples, the wireless network services 1120 may include central processors 1122, servers 1124, and databases 1126. In some embodiments, the network 1102 is agnostic to local interfaces and networks associated with the client devices to allow for integration of the local interfaces and networks configured to perform the processes described herein. Additionally, external devices such as the cellular telephone 1110, tablet computer 1112, and mobile computing device 1114 may communicate with the mobile network services 1120 via a base station 1156, access point 1154, and/or satellite 1152.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

While certain embodiments have been described, these embodiments have been presented by way of example only and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. A system comprising:
processing circuitry;
a non-transitory database storage region; and
a non-transitory computer readable memory coupled to the processing circuitry, the memory storing machine-executable instructions, wherein the machine-executable instructions, when executed on the processing circuitry, cause the processing circuitry to
receive, from a remote computing device of a user via a network, a risk exposure analysis request for a user portfolio comprising a plurality of locations, wherein the request includes an analysis radius,
calculate, for each location of the plurality of locations, a risk exposure accumulation value indicating an amount of catastrophic risk exposure for an area that includes the respective location and including the analysis radius,
identify, based on the calculated risk exposure accumulation values for each of the plurality of locations, one or more regions of interest based on a respective combined risk exposure accumulation value for the one or more regions of interest corresponding to groupings of two or more of the plurality of locations exceeding a predetermined risk exposure accumulation value,
generate, for each of the one or more regions of interest, a grid comprising a plurality of intermediate points for applying to each of the one or more regions of interest,
calculate, for each of the plurality of intermediate points applied to the respective region of interest, an intermediate point exposure accumulation value for the respective intermediate point indicating an intermediate amount of catastrophic risk exposure from a portion of the plurality of locations that fall within a predetermined distance of the analysis radius of the respective intermediate point, wherein at least a subset of the plurality of intermediate points lie outside any location of the plurality of locations,
identify, based on the respective intermediate point exposure accumulation values for the plurality of intermediate points applied to the respective region of interest, one or more intermediate points of interest based on the respective intermediate point exposure accumulation value of each of the one or more intermediate points exceeding at least one of the calculated risk exposure accumulation value for at least one of the plurality of locations, and
output, to the remote computing device of the user, a risk exposure analysis comprising the calculated exposure accumulation values for the plurality of locations and the intermediate point exposure accumulation values for the one or more intermediate points of interest.

2. The system of claim 1, wherein generating the grid comprises determining a customized spacing amount between each of the plurality of intermediate points.

3. The system of claim 2, wherein the machine-executable instructions, when executed on the processing circuitry, cause the processing circuitry to receive, from the remote computing device of the user, one or more analysis parameters, wherein the customized spacing amount is determined based at least in part on at least one of the one or more analysis parameters.

4. The system of claim 1, wherein outputting the risk exposure analysis comprises displaying the calculated exposure accumulation values for the plurality of insured locations and the intermediate point exposure accumulation values for the one or more intermediate points of interest in a heat map format overlaid on a map including the locations.

5. The system of claim 1, wherein:
the request comprises at least one type of catastrophic event; and
calculating the risk exposure accumulation value comprises calculating, in view of the at least one type of catastrophic event, the risk exposure accumulation value.

6. The system of claim 1, wherein outputting the risk exposure analysis comprises outputting, in real-time responsive to receiving the risk exposure analysis request, the risk exposure analysis.

7. The system of claim 1, wherein calculating the accumulation value comprises accessing, from the user portfolio, geographical coordinates and exposure values corresponding to each location of the plurality of locations.

8. The system of claim 1, wherein:
calculating the risk exposure accumulation value for the area including the analysis radius comprises matching the analysis radius to a tile size of a plurality of tile sizes of tile data stored in a non-transitory computer readable data store, wherein
matching comprises meeting or exceeding the analysis radius, and
each tile of the tile data comprises a geographic region.

9. The system of claim 8, wherein identifying the one or more regions of interest comprises calculating, within a given tile of the tile data and/or within a grouping of proximate tiles of the tile data including the given tile, the combined risk exposure accumulation value.

10. The system of claim 1, wherein generating the grid comprises applying a spatial buffer of the analysis radius around the tile of the tile data corresponding to the region of interest and applying a grid of intermediate points to the spatial buffer.

11. The system of claim 1, wherein calculating the intermediate point exposure accumulation value comprises assigning, as intermediate point data stored to a non-transitory computer readable data store, the intermediate point exposure accumulation value to the respective intermediate point.

12. The system of claim 11, further comprising sorting the intermediate point data for each intermediate point of at least a portion of the plurality of intermediate points to discard overlapping data from exposure analysis.

13. A method for performing multi-level catastrophic risk exposure analysis for a portfolio of locations, the method comprising:
receiving, from a remote computing device of a user via a network, a risk exposure analysis request for a user portfolio comprising a plurality of locations, wherein the request includes an analysis radius;
calculating, by processing circuitry for each location of the plurality of locations, a risk exposure accumulation value indicating an amount of catastrophic risk exposure for an area that includes the respective location and including the analysis radius;
identifying, by the processing circuitry based on the calculated risk exposure accumulation values for each of the plurality of locations, one or more regions of interest based on a respective combined risk exposure accumulation value for the one or more regions of interest corresponding to groupings of two or more of the plurality of locations exceeding a predetermined risk exposure accumulation value;
generating, by the processing circuitry for each of the one or more regions of interest, a grid comprising a plurality of intermediate points for applying to each of the one or more regions of interest;
calculating, by the processing circuitry for each of the plurality of intermediate points applied to the respective region of interest, an intermediate point exposure accumulation value for the respective intermediate point indicating an intermediate amount of catastrophic risk exposure from a portion of the plurality of locations that fall within a predetermined distance of the analysis radius of the respective intermediate point, wherein at least a subset of the plurality of intermediate points lie outside any location of the plurality of locations;
identifying, by the processing circuitry based on the respective intermediate point exposure accumulation values for the plurality of intermediate points applied to the respective region of interest, one or more intermediate points of interest based on the respective intermediate point exposure accumulation value of each of the one or more intermediate points exceeding at least one of the calculated risk exposure accumulation value for at least one of the plurality of locations, and
preparing, by the processing circuitry for output to the remote computing device of the user, a risk exposure analysis comprising the calculated exposure accumulation values for the plurality of locations and the intermediate point exposure accumulation values for the one or more intermediate points of interest.

14. The method of claim 13, wherein:
calculating the risk exposure accumulation value for the area including the analysis radius comprises matching the analysis radius to a tile size of a plurality of tile sizes of tile data stored in a non-transitory computer readable data store, wherein
matching comprises meeting or exceeding the analysis radius, and
each tile of the tile data comprises a geographic region.

15. The method of claim 14, further comprising assigning each location of the plurality of locations to a tile of the tile data encompassing a geographic position of the location.

16. The method of claim 14, wherein generating the grid comprises forming a tile grouping corresponding to the region of interest comprising a set of eight adjacent tiles surrounding a center tile.

17. The method of claim 13, wherein generating the grid comprises determining a spacing between each of the plurality of intermediate points.

18. The method of claim 17, wherein the spacing is identified in latitude stride amount and longitude stride amount.

19. The method of claim 13, wherein the risk exposure analysis is output as a dynamic display overlaid on a map.

20. The method of claim 13, wherein:
the request comprises at least one type of catastrophic event; and
calculating the risk exposure accumulation value comprises calculating, in view of the at least one type of catastrophic event, the risk exposure accumulation value.
